(19) United States
(12) Patent Application Publication
(10) Pub. No.: US 2019/0354491 A1
(43) Pub. Date: Nov. 21, 2019

(54) INFORMATION PROCESSING DEVICE AND METHOD, AND PROGRAM

(71) Applicant: SONY CORPORATION, TOKYO (JP)

(72) Inventors: KENTA TADA, TOKYO (JP); YU TANAKA, TOKYO (JP)

(21) Appl. No.: 16/476,442

(22) PCT Filed: Jan. 4, 2018
(86) PCT No.: PCT/JP2018/000042

§ 371 Date: Jul. 8, 2019

(30) Foreign Application Priority Data
Jan. 17, 2017 (JP) 2017-006125

(51) Int. Cl. G06F 13/12; G06Q 50/22; G06F 21/62; G06F 16/174; H04L 9/06; G06F 16/22

(52) U.S. Cl. CPC G06F 13/126; G06Q 50/22; G06F 16/2255; G06F 16/1744; H04L 9/0643; G06F 21/62

(57) ABSTRACT

The present technology relates to an information processing device that is adapted to be capable of transmitting/receiving data with smaller amounts of processing and data, and a method, and a program. The information processing device is provided with: a control unit that subjects information related to a collection target user to computation using one or more predetermined functions, and generates collected data on the basis of a result of the computation; and a communication unit that transmits the collected data. The present technology can be applied to a statistical information-sharing system.

### TECHNICAL FIELD

The present technology relates to an information processing device and a method, and a program, and in particular, to an information processing device that is adapted to be capable of transmitting/receiving data with smaller amounts of processing and data, and a method, and a program.

### BACKGROUND ART

There is known a system in which, for example, a server collects target data from a terminal device of a user or the like, and performs statistical processing or the like on the basis of a large number of pieces of collected data.

As such a system, a system in which data related to an infectious disease is collected, and the collected data is mapped to geographical information so as to analyze the infectious disease is proposed (refer to, for example, patent document 1).

### CITATION LIST

### Patent Document

Patent Document 1: International Publication No. 2002/061647

### SUMMARY OF THE INVENTION

### Problems to be Solved by the Invention

Incidentally, data as a collection target, for example, data related to a disease of a user, is often required to be anonymized. Therefore, when the data is transmitted/received, encryption processing may be required in order to ensure anonymity. However, performing such encryption processing causes the processing amount at the time of transmitting/receiving data to increase.

In addition, in a case where collection target data itself, in other words, unprocessed data, is transmitted with the data encrypted, the amount of data increases depending on a classification of the collection target data, and consequently the processing amount of encryption processing further increases.

The present technology has been devised in consideration of such a situation, and enables to transmit/receive data with smaller amounts of processing and data.

### Solutions to Problems

An information processing device according to a first aspect of the present technology includes: a control unit that subjects information related to a collection target user to computation using one or more predetermined functions, and generates collected data on the basis of a result of the computation; and a communication unit that transmits the collected data.

The control unit causes a recording unit to record a pair of the collected data and time information indicating the time at which the information related to the user has been obtained; and the communication unit transmits a plurality of the pairs that have been obtained during a predetermined time period, the pairs being recorded in the recording unit.

The control unit subjects a part of a plurality of pieces of the collected data to dummy data conversion processing, and finally treats dummy data obtained by the dummy data conversion processing as the part of the collected data.

The communication unit transmits related information that relates to the information related to the user, and that is used for statistical processing based on the collected data, and the plurality of the pairs.

The information processing device further includes a compression processing unit that subjects the collected data to lossless compression processing; and the communication unit transmits the collected data that has been subjected to the lossless compression.

The function is a hash function.

The collected data is a bloom filter table.

After the generation of the collected data, the control unit discards the information related to the user.

The information related to the user is sensitive data.

An information processing method or program according to the first aspect of the present technology includes the steps of: subjecting information related to a collection target user to computation using one or more predetermined functions, and generating collected data on the basis of a result of the computation; and transmitting the collected data.

In the first aspect of the present technology, information related to a collection target user is subjected to computation using one or more predetermined functions, and collected data is generated on the basis of a result of the computation; and the collected data is transmitted.

An information processing device according to a second aspect of the present technology includes: a communication unit that receives collected data from a plurality of terminal devices, the collected data having been obtained from information related to a collection target user; and a control unit that compares the collected data for comparison with the collected data received from the terminal device, and that performs statistical processing according to a result of the comparison, the collected data for comparison having been generated on the basis of results of computation that uses one or more predetermined functions, and that is performed for predetermined information.

The communication unit receives, from the terminal device, a plurality of pairs of the collected data and time information indicating the time at which the information related to the user has been obtained, the plurality of pairs having been obtained during a predetermined time period; and the control unit performs the statistical processing on the basis of the comparison result and the time information.

The communication unit receives related information that relates to the information related to the user, and a plurality of the pairs; and the control unit performs the statistical processing on the basis of the comparison result, the time information, and the related information.

The communication unit receives the collected data that has been subjected to lossless compression processing; and the information processing device further includes a restoration processing unit that subjects the collected data to restoration processing.

The function is a hash function.

The collected data is a bloom filter table.

The information related to the user is sensitive data.

An information processing method or program according to the second aspect of the present technology includes the steps of: receiving collected data from a plurality of terminal devices, the collected data having been obtained from information related to a collection target user; and comparing the collected data for comparison with the collected data received from the terminal device, and performing statistical processing according to a result of the comparison, the collected data for comparison having been generated on the basis of results of computation that uses one or more predetermined functions, and that is performed for predetermined information.

In the second aspect of the present technology, collected data is received from a plurality of terminal devices, the collected data having been obtained from information related to a collection target user; and the collected data for comparison is compared with the collected data received from the terminal device, and statistical processing is performed according to a result of the comparison, the collected data for comparison having been generated on the basis of results of computation that uses one or more predetermined functions, and that is performed for predetermined information.

### Effects of the Invention

According to the first and second aspects of the present technology, data can be transmitted/received with smaller amounts of processing and data.

It should be noted that the effects described herein are not necessarily limited, and may be any one of the effects described in the present disclosure.

### BRIEF DESCRIPTION OF DRAWINGS

FIG. 1 is a drawing illustrating a configuration example of a statistical information-sharing system;

FIG. 2 is a drawing illustrating a bf table;

FIG. 3 is a drawing illustrating recording of the bf table;

FIG. 4 is a diagram illustrating a configuration example of a terminal device;

FIG. 5 is a diagram illustrating a configuration example of a server;

FIG. 6 is a flowchart illustrating data obtaining processing;

FIG. 7 is a flowchart illustrating data transmission processing;

FIG. 8 is a flowchart illustrating data receiving processing; and

FIG. 9 is a diagram illustrating a configuration example of a computer.

### MODE FOR CARRYING OUT THE INVENTION

Embodiments to which the present technology is applied will be described below with reference to the accompanying drawings.

### First Embodiment

Configuration Example of Statistical Information-Sharing System

In the present technology, collection target data is subjected to computation that uses predetermined functions, and data obtained as results of the computation is transmitted/received, thereby enabling to transmit/receive data with smaller amounts of processing and data.

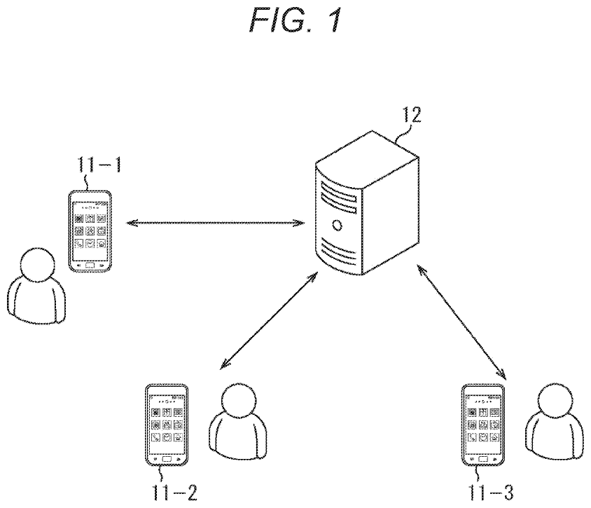

FIG. 1 is a drawing illustrating a configuration example of a statistical information-sharing system to which the present technology is applied.

The statistical information-sharing system shown in FIG. 1 includes terminal devices 11-1 to 11-3, and a server 12, which are mutually connected through a wired or wireless communication network.

The terminal devices 11-1 to 11-3 include, for example, user terminal devices, such as a portable telephone, a tablet-type terminal device, and a personal computer, the user terminal devices being possessed by users; and the terminal devices 11-1 to 11-3 transmit collection target data to the server 12.

It should be noted that, hereinafter, in a case where it is not particularly necessary to distinguish among the terminal devices 11-1 to 11-3, the terminal devices 11-1 to 11-3 are also referred to as merely the terminal devices 11. In addition, although the number of the terminal devices 11 is three here, the number of the terminal devices 11 is not limited.

The server 12 receives the collection target data transmitted from each of the terminal devices 11, and performs statistical processing on the basis of the received data so as to generate statistical information.

The users can browse the statistical information obtained in this manner. In other words, the terminal devices 11 are capable of receiving the statistical information from the server 12 to display the statistical information.

Here, the collection target data is information (data) related to the users. For example, the collection target data may be data that is preferably anonymized although it is not always necessary to anonymize the data, the data including information indicating preferences of the users, information indicating words that have been searched for by the users, and the like, or may be sensitive data (sensitive information) that is required to be anonymized, in other words, that is required to be handled with care, the sensitive data including information related to user's behavior histories and the like.

The description will be continued below by taking, as an example, a case where the statistical information-sharing system provides services for sharing statistical information related to infectious diseases.

In this case, the server 12 is an information processing device that is managed by a service provider that provides services, and the service provider prepares beforehand infectious disease data statistical processing system for providing services, in other words, the server 12.

In addition, the terminal devices 11 obtain, as collection target data, position information indicating current positions of the users, in other words, the terminal devices 11, at each time respectively, and provide the server 12 with the position information.

For example, in the statistical information-sharing system, for example, users may provide the server 12 with collection target data as exchange conditions under which the users are provided with statistical information.

The server 12 receives collection target data from the plurality of terminal devices 11 periodically, or as necessary, and performs statistical processing on the basis of the received data, thereby generating information indicating statistical results related to infectious diseases as statistical information.

Specifically, the statistical information is statistical information indicating, for example, when, where, what kind of disease, and the number of persons who have been infected with the disease or the like, for example, the statistical information indicating that in a live music club A located at 1-2-345, Dogenzaka, Shibuya-ku, 20 persons have been infected with influenza about in the evening on October 21.

In this case, each of the terminal devices 11 provides the server 12 with not only position information that is collection target data, but also infectious disease name information indicating a disease name of a disease with which the user has been infected, and time information indicating the time at which the position information has been obtained. This infectious disease name information is related information that relates to position information, which is information (data) related to a user as a collection target, and that is used for statistical processing, in other words, the generation of statistical information, based on the position information in the server 12. Here, the related information is information related to a disease of a user, that is to say, a disease name of the infectious disease with which the user has been infected at a position (place) indicated by the position information.

Hereinafter, data that is transmitted from the terminal device 11 to the server 12, the data including position information, infectious disease name information, and time information, is also referred to as infectious disease data. It should be noted that in more detail, the position information is provided to the server 12 by being processed in the terminal device 11. In other words, the infectious disease data includes position information in a processed state.

For example, the timing in which infectious disease data is transmitted from the terminal device 11 to the server 12 is, for example, the timing in which a user who is an owner of the terminal device 11 has received, from a doctor, a diagnosis indicating that the user has been infected with a specific infectious disease. The terminal device 11 transmits (uploads) infectious disease data to the server 12 by using, for example, a preinstalled application program or the like.

In addition, in a case where the server 12 periodically collects infectious disease data from the terminal device 11 to generate (update) statistical information, for example, the number of times statistical information related to a popular spot is searched for is large. Therefore, for example, the statistical information may be updated focusing on the popular spot, in other words, the statistical information related to the popular spot may be updated with high frequency.

Since statistical information related to infectious diseases is provided by the server 12, for example, in a case where a user had a slight cold after having visited a specific place at the predetermined date and time, the user can browse the statistical information by using the terminal device 11 so as to check, for example, whether or not the user himself/herself is suspected of having been infected with an infectious disease.

Specifically, for example, the user can browse statistical information related to infectious diseases classified according to the specific position and the specific date and time, for example, the number of influenza patients in the live music club A in Shibuya about 14:00 yesterday. This enables the user to quickly take a proper reaction, for example, going to a hospital as appropriate.

Data collection and Statistical Processing

Data collection and statistical processing will be more specifically described.

For example, the terminal device 11 uses a position measurement system such as a Global Positioning System (GPS) to obtain position information indicating a current position of a user, in other words, a movement history of the user, every fixed time period. In addition, immediately after obtaining the position information, the terminal device 11 generates a bloom filter table (hereinafter referred to as “bf table”) indicating a current position on the basis of the position information.

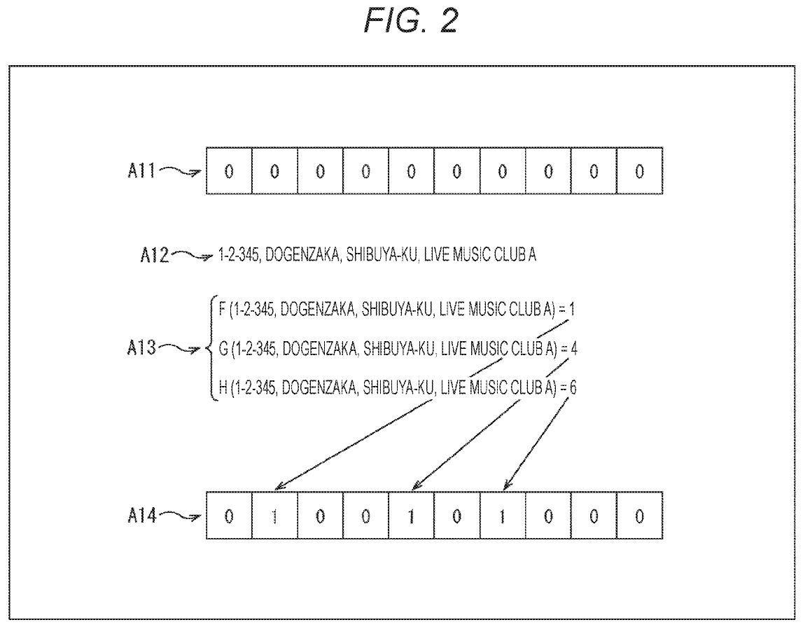

In other words, the terminal device 11 supplies the pre-defined bf table to a memory as shown in, for example, an arrow A11 of FIG. 2, and causes the memory to temporarily record the bf table.

In this example, the bf table is data of a bit string obtained by arranging a predetermined number of “0” values.

In addition, it is assumed that in the terminal device 11, as position information indicating a current position of a user, position information that includes an address indicating the position of the user, and a facility name, that is to say, “1-2-345, Dogenzaka, Shibuya-ku, Live Music Club A”, has been obtained as shown in an arrow A12. In this example, the obtained position information is data (information) related to the user as the collection target.

The terminal device 11 performs computation that uses one or more hash functions, the hash functions being held beforehand for the obtained position information.

For example, it is assumed that the terminal device 11 holds three predetermined hash functions F(x), G(x) and H(x).

In this case, as shown in an arrow A13, the terminal device 11 substitutes the position information “1-2-345, Dogenzaka, Shibuya-ku, Live Music Club A” in each of the hash functions F(x), G(x) and H(x) as a variable, and thereby determines hash values (indexes).

In this example, a hash value “1” is obtained as a result of the computation that uses the hash function F(x), a hash value “4” is obtained as a result of the computation that uses the hash function G(x), and a hash value “6” is obtained as a result of the computation that uses the hash function H(x).

Next, the terminal device 11 maps each hash value in the bf table shown by the arrow A11, and thereby obtains the bf table indicating the current position of the user.

In other words, the hash value obtained as the computation result is used as an offset of the bf table, and thus a bit part at a position determined by the hash value, among bits constituting the bf table, is converted into “1” to set the bit to “1”. Consequently, the final bf table is obtained.

Specifically, as shown in, for example, an arrow A14, corresponding to the hash value “1” obtained by the hash function F(x), a value of the first bit from the top of the bf table is changed from “0” to “1”. It should be noted that here, in the figure, a position of the left end corresponds to the 0-th position from the top, and a position immediately to the right of the left end corresponds to the first position from the top. Similarly, a position corresponding to m bits counted from the left end of the bf table corresponds to a position of the (m−1)-th bit from the top.

In addition, corresponding to the hash value “4” obtained by the hash function G(x), a value of the fourth bit from the top of the bf table is changed from “0” to “1”; and corresponding to the hash value “6” obtained by the hash function H(x), a value of the sixth bit from the top of the bf table is changed from “0” to “1”.

In addition, the bf table that has been finally obtained in this manner is used as the bf table indicating the current position of the user. This bf table is collected data collected by the server 12.

The position information indicating the current position, which is “1-2-345, Dogenzaka, Shibuya-ku, Live Music Club A”, shows a position (place) of the user at some specific time, and time-series position information is data indicating a movement history (behavior history) of the user. Therefore, such position information is data that is required to be anonymized when the data is transmitted/received to/from the server 12; in other words, such position information is sensitive data.

Accordingly, the terminal device 11 anonymizes position information by converting the position information into the bf table. In other words, the bf table is data obtained by processing original position information that is raw data, and therefore the data has anonymity. Therefore, it can be said that the processing of generating the bf table by using hash functions is processing of converting position information for the purpose of anonymization.

It should be noted that a kind of function used as a hash function, and the total number of hash functions to be used, may be selected beforehand by a service provider as appropriate. For example, although an increase in the number of hash functions decreases the anonymity of the bf table, pseudo positiveness can be reduced.

In addition, here, the example in which the position information is converted into the bf table in order to ensure the anonymity has been described. However, besides the above, position information is subjected to computation that uses one or more arbitrary functions, and subsequently data corresponding to results of the computation may be used as position information that has been subjected to anonymization processing.

When the bf table has been obtained as described above, the terminal device 11 records, as a bf table log, the obtained bf table in a nonvolatile recording unit (storage) of the terminal device 11 with the bf table associated with time information indicating the time at which the position information has been obtained.

At this point, after the generation of the bf table, position information that has been temporarily recorded in the memory is discarded (erased). Therefore, original position information is not recorded at all in the terminal device 11.

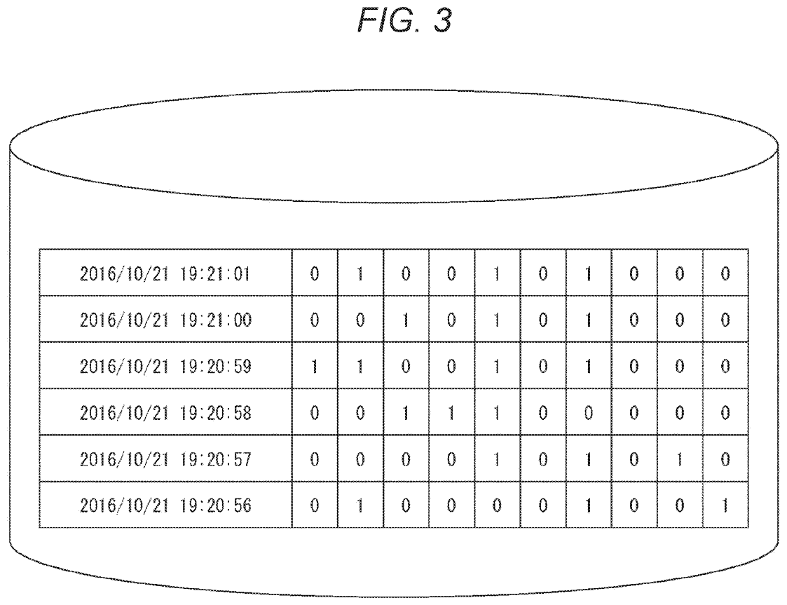

As shown in, for example, FIG. 3, a pair of time information indicating each time and the bf table, which have been obtained at fixed time intervals, are recorded in the terminal device 11 for a predetermined time period.

In the example shown in FIG. 3, in order to simplify the explanation, six pairs of the time information and the bf table, which have been obtained at intervals of one second, are recorded.

For example, in the figure, “2016/10/21 19:21:01” on the uppermost side indicates time information, in other words, the date and time on which the position information indicated by the bf table has been obtained; and “0100101000” indicates the bf table.

Here, in the figure, the pair of the time information and the bf table on the lowermost side have been obtained at the earliest time; and in the figure, the pair of the time information and the bf table on the uppermost side have been obtained at the latest time.

In a case where new position information has been obtained in such a state, a pair of the new time information and the bf table obtained for the position information are overwritten to the pair of the time information and the bf table obtained at the earliest time. In other words, the pair of the time information and the bf table obtained at the earliest time are replaced with the new pair of the time information and the bf table.

It should be noted that here, in order to simplify the explanation, the example in which only six pairs of the time information and the bf table are recorded has been described. However, in actuality, pairs of the time information and the bf table, which have been obtained for three days at intervals of, for example, one second, are, for example, recorded. In this case, a log of the bf table is updated with a rotation period of three days.

Moreover, in more detail, in order to further enhance the anonymity, dummy data is also inserted into pair groups of the time information and the bf table recorded in the terminal device 11.

In other words, the position information indicating the current position of the user is information close to personal information of the user, and therefore, for the purpose of protecting such information, the terminal device 11 further performs dummy data conversion processing for a part of the bf table before the bf table is saved in a storage.

Specifically, a part of the plurality of bf tables recorded in the storage is subjected to the dummy data conversion processing, and dummy data obtained as a result of the dummy data conversion processing is used as the final bf table. In this case, dummy data as the final bf table obtained by the dummy data conversion processing, and remaining bf tables that have not been subjected to the dummy data conversion processing, are recorded in the storage. The bf tables may be subjected to the dummy data conversion processing at a ratio of, for example, one to ten.

For example, as the dummy data conversion processing, processing of shifting bit masked positions of the bf table at random at a constant probability, in other words, processing of shifting positions of bits each having a value of “1”, and the like can be considered.

In addition, for example, as the dummy data conversion processing, processing of copying the bf table of another time zone so as to minimize a data distortion degree can be considered, in other words, processing of using the bf table at another time as it is as the bf table (dummy data) at the time for target processing can also be considered. Moreover, it can also be considered that as the dummy data conversion processing, some different processings are performed in combination.

It should be noted that whether or not to subject the bf table to the dummy data conversion processing, a kind of dummy data conversion processing to be performed, or the like, may be set in accordance with the purpose of the service provider.

For example, whether or not to convert the bf table into dummy data may be set on a service provider basis, or a service provider may be allowed to specify a conversion function that realizes the dummy data conversion processing, so as to adjust an approximation degree between the original bf table and the dummy data.

When the approximation degree between the bf table and the dummy data is adjusted, the adjustment may be set in such a manner that, for example, the recorded bf tables are mixed with 5% of totally random data, and 5% of data that is similar to original data to some extent, as a whole.

As described above, in the terminal device 11, a new bf table is generated at regular time intervals, and pairs of the time information and the bf table obtained for a predetermined time period are held.

In addition, when the timing of transmitting infectious disease data that includes these pairs of the time information and the bf table comes, all recorded pairs of the time information and the bf table are read, and the infectious disease data that includes those pieces of time information and the bf tables is transmitted to the server 12.

For example, when a transmission opportunity preset by a service provider comes, for example, in the timing in which a doctor's diagnosis has found out user's infection with an infectious disease during a specified time period, the infectious disease data is generated, and is then transmitted to the server 12.

At this point, data is generated as infectious disease data, the generated data including, for example: pairs of the time information and the bf table obtained for a predetermined time period; and infectious disease name information indicating a name of an infectious disease with which the user has been infected.

Meanwhile, in a case where user's infection with an infectious disease has not been found out during the specified time period, the pairs of the time information and the bf table for these few days are discarded from the storage, and the accumulation of the pieces of time information and the bf tables in the storage is started again. In more detail, a pair of the time information and the bf table is generated at fixed time intervals, and is then overwritten to the pair of the time information and the bf table obtained at the earliest time.

In this manner, by adapting the bf table log to be rotated (updated) every time the specified number of days elapses, a mechanism for always recording the latest bf table log that covers the specified number of days can be realized. In other words, the latest bf table log that covers the specified numbers of days can be continuously obtained.

Here, in the bf table that is transmitted to the server 12, only a bit at a specific position is set to “1”, and values at the other bit positions are set at “0”, and therefore many “0” values continuously exist. Therefore, the bf table has a data characteristic that enables to increase a compression efficiency relatively easily.

Accordingly, the terminal device 11 may be adapted to subject infectious disease data to lossless compression processing as appropriate when the infectious disease data is transmitted.

In this case, for example, the time information, the bf table, and the infectious disease name information are subjected to the lossless compression processing, and data obtained as the result thereof is infectious disease data, in other words, the infectious disease data is data that includes: the time information, the bf table, and the infectious disease name information, which have been compressed (encoded); and a compression flag indicating whether or not lossless compression processing has been performed. It should be noted that at least the bf table among the time information, the bf table, and the infectious disease name information has only to be subjected to the lossless compression processing.

In this manner, compressing the bf table and the like enables to reduce the amount of infectious disease data transmitted/received between the terminal device 11 and the server 12, and to reduce the amount of data transfer, and the processing amount of processing related to data transmission and receiving.

In addition, when the server 12 receives infectious disease data from the terminal device 11, the server 12 updates statistical information on the basis of the infectious disease data.

For example, in the server 12, a specific position that is a target of statistics related to an infectious disease is predetermined. Further, with respect to the predetermined specific position, the server 12 holds a bf table as a comparison bf table beforehand, the bf table being obtained from position information indicating the specific position, and one or more predetermined hash functions.

Specifically, it is assumed that the position of “Live Music Club A” described with reference to, for example, FIG. 2 is a position that is a statistics target. In such a case, position information “1-2-345, Dogenzaka, Shibuya-ku, Live Music Club A” indicating the position is subjected to computation that uses predetermined hash functions, and a bf table is generated on the basis of hash values obtained as the computation result. In addition, the bf table “0100101000” obtained in such a manner is held in the server 12 as the comparison bf table beforehand.

It should be noted that in the server 12, hash functions that are the same as those used to generate the bf table in the terminal device 11 are used to generate the comparison bf table in the server 12.

When the server 12 receives infectious disease data from the terminal device 11, the server 12 subjects the received infectious disease data to restoration processing (decoding processing) as appropriate to obtain the bf table at each time. Subsequently, the server 12 compares the obtained bf table with the comparison bf table.

When the bf table is compared with the comparison bf table, with respect to, for example, bit positions at which respective values in the comparison bf table are “1”, AND operation of values is performed between the bf table and the comparison bf table at the bit positions. Subsequently, for example, if results of the AND operation are all “1”, it is determined that the comparison bf table agrees with the bf table.

As the result of the comparison, for example, in a case where the bf table agrees with the comparison bf table, it is determined that there is a high possibility that a user has been infected with an infectious disease indicated by the infectious disease name information included in the infectious disease data, in a place (at a position) indicated by the bf table, at the time (the date and time) indicated by the time information associated with the bf table.

Accordingly, the server 12 performs statistical processing of reflecting the determination result in recorded statistical information, thereby updating (generating) the statistical information. In other words, the statistical processing is performed according to the result of comparison between the bf table and the comparison bf table.

Performing such processing enables to obtain statistical information indicating when (the date and time and a time zone), and how many users have been infected with the infectious disease in a predetermined specific place, in other words, in a place indicated by the comparison bf table. It should be noted that the server 12 may record infectious disease data of each user so as to generate statistical information by using the infectious disease data of each user, and the comparison bf table in the specific timing.

In addition, in the statistical information-sharing system, position information that is unprocessed raw data is not handled between the terminal device 11 and the server 12, and in the server 12. Therefore, the statistical information-sharing system may be a P2P type network system or a server type network system.

However, in the case of both the P2P type network system and the server type network system, it is necessary to conceal algorithm of hash functions used to generate the bf table from persons other than the service provider.

Configuration Example of Terminal Device

Subsequently, configuration examples of the terminal device 11 and the server 12 shown in FIG. 1 will be described.

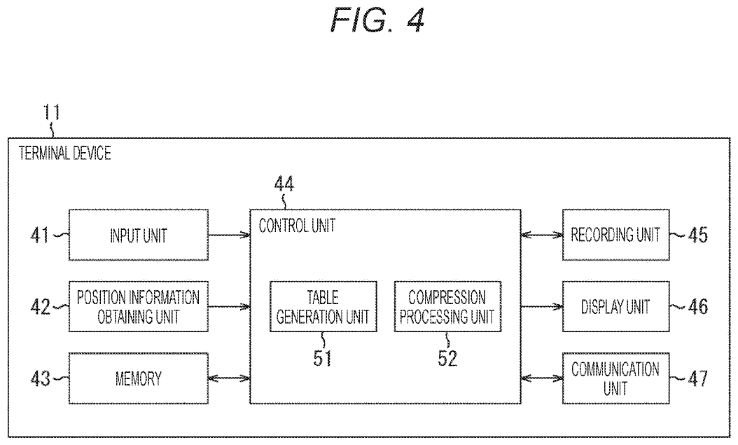

First of all, a configuration example of the terminal device 11 will be described. The terminal device 11 is configured as shown in, for example, FIG. 4.

The terminal device 11 includes an input unit 41, a position information obtaining unit 42, a memory 43, a control unit 44, a recording unit 45, a display unit 46, and a communication unit 47.

The input unit 41 includes, for example, a button, a switch, a touch panels that is provided so as to be superimposed on the display unit 46, and the like. The input unit 41 supplies a signal corresponding to user's operation to the control unit 44. The position information obtaining unit 42 includes, for example, a position measurement system such as a GPS and the like. The position information obtaining unit 42 obtains position information indicating a current position of a user as appropriate by using map information or the like as well, and then supplies the position information to the control unit 44.

The memory 43 is a volatile recording unit. The memory 43 temporarily records data supplied from the control unit 44, and supplies the recorded data to the control unit 44.

The control unit 44 controls the operation of the terminal device 11 as a whole. The control unit 44 includes a table generation unit 51, and a compression processing unit 52.

The table generation unit 51 generates the bf table on the basis of the position information supplied from the position information obtaining unit 42. The compression processing unit 52 subjects the time information and the bf table recorded in the recording unit 45, and infectious disease name information generated by the control unit 44, to lossless compression processing.

The recording unit 45 includes, for example, a nonvolatile recording media such as a hard disk. The recording unit 45 records various data such as pairs of the time information and the bf table supplied from the control unit 44, and supplies the recorded data to the control unit 44.

The display unit 46 includes, for example, a liquid crystal display panel and the like, and displays various images or the like on the basis of data supplied from the control unit 44. The communication unit 47 receives data transmitted from the outside to supply the data to the control unit 44, and transmits data supplied from the control unit 44.

Configuration Example of Server

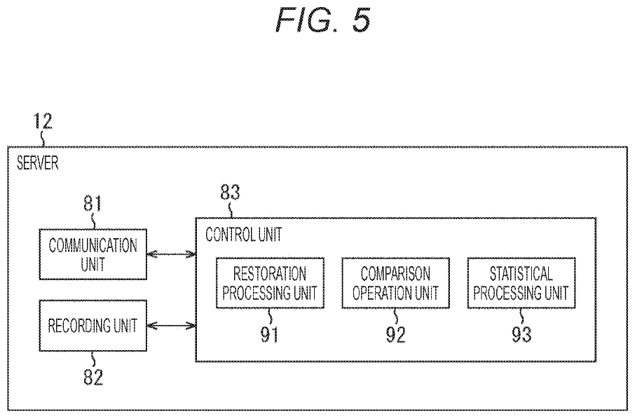

Next, a configuration example of the server 12 will be described. The server 12 is configured as shown in, for example, FIG. 5.

The server 12 shown in FIG. 5 includes a communication unit 81, a recording unit 82, and a control unit 83.

The communication unit 81 receives data transmitted from the outside to supply the data to the control unit 83, and transmits data supplied from the control unit 83. The recording unit 82 records various data such as statistical information supplied from the control unit 83, and supplies recorded data to the control unit 83.

The control unit 83 controls operation of the server 12 as a whole. The control unit 83 includes a restoration processing unit 91, a comparison operation unit 92, and a statistical processing unit 93.

The restoration processing unit 91 subjects infectious disease data received from the terminal device 11 to restoration processing. The comparison operation unit 92 performs computation processing of comparing the comparison bf table that is held beforehand with the bf table included in the infectious disease data.

The statistical processing unit 93 performs statistical processing in which statistical information is generated on the basis of infectious disease data, and the statistical information is updated, according to the result of comparison between the comparison bf table and the bf table.

Explanation of Data Obtaining Processing

Subsequently, operations of the terminal device 11 and the server 12 will be described.

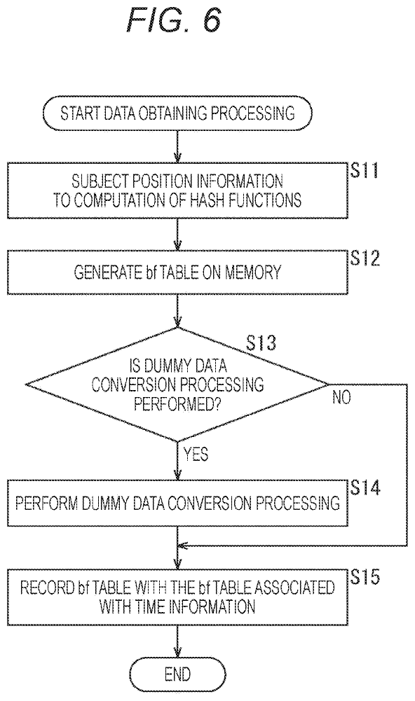

First of all, data obtaining processing performed by the terminal device 11 will be described with reference to a flowchart shown in FIG. 6. This data obtaining processing is performed at fixed time intervals, and is started when, for example, the timing of obtaining predetermined position information comes.

In a step S11, the table generation unit 51 subjects position information to computation of hash functions.

In other words, the position information obtaining unit 42 uses a position measurement system, map information or the like to obtain position information indicating a current position of a user, that is to say, the terminal device 11, and supplies the position information to the control unit 44.

The table generation unit 51 of the control unit 44 subjects the position information supplied from the position information obtaining unit 42 to computation for determining hash values by using one or more predetermined hash functions. At this point, the table generation unit 51 temporarily records position information or the like on the memory 43 as appropriate, and performs computation for calculating hash values.

For example, the position information is substituted in the hash functions F(x), G(x) and H(x) so as to calculate hash values. As the result, hash values as indexes used to generate the bf table are obtained.

In a step S12, the table generation unit 51 generates the bf table on the memory 43 on the basis of the hash values obtained in the processing of the step S11.

In other words, the table generation unit 51 records, on the memory 43, the bf table in which a value at each bit position is “0”. Subsequently, the table generation unit 51 performs processing of rewriting values at bit positions indicated by respective hash values in the bf table to “1”, and thereby generates the bf table indicating a current position of the user. In other words, processing of anonymizing position information is performed, and consequently the position information is converted into the bf table.

In addition, after the bf table is generated, the table generation unit 51 discards the position information that is temporarily recorded on the memory 43 in order to generate the bf table, for example. As the result, the position information is not recorded in the terminal device 11, in other words, the position information is prevented from being left as recorded information, which enables to enhance the security.

In a step S13, the table generation unit 51 determines whether or not to perform dummy data conversion processing.

For example, in a case where the dummy data conversion processing is set to be performed, and in a case where the timing of performing the dummy data conversion processing comes, it is determined in the step S13 that the dummy data conversion processing is performed. As an example, if a bf table is recorded without being subjected to the dummy data conversion processing, for example, for a predetermined number of minutes in succession, a bf table generated subsequent thereto is subjected to the dummy data conversion processing.

It should be noted that the predetermined number described here may always be a constant number, or may change at random in each timing. In addition, in each timing in which the dummy data conversion processing is performed, the same processing may be performed, or different processing may be performed, as the dummy data conversion processing.

In a case where it is determined in the step S13 that the dummy data conversion processing is performed, in a step S14, the table generation unit 51 subjects the bf table that has been generated in the step S12, and that is recorded on the memory 43, to the dummy data conversion processing.

The dummy data conversion processing is performed, and the bf table is converted into dummy data. Subsequently, the process proceeds to a step S15.

Meanwhile, in a case where it is determined in the step S13 that the dummy data conversion processing is not performed, the processing in the step S14 is not performed, and the process proceeds to the step S15.

In the terminal device 11, position information is converted into the bf table, and a part of all bf tables is subjected to the dummy data conversion processing, which enables to enhance the anonymity of data. This eliminates the need for performing encryption processing, for example, at the time of the transmission of the bf table, and consequently the processing amount can be reduced.

When it is determined in the step S13 that the dummy data conversion processing is not performed, or when the dummy data conversion processing is performed in the step S14, the table generation unit 51 records the bf table on the recording unit 45 by being associated with time information in a step S15.

In other words, the table generation unit 51 reads the bf table on the memory 43, supplies the bf table to the recording unit 45 with the bf table associated with time information indicating the time at which position information for the bf table has been obtained, and causes the recording unit 45 to record the bf table. Subsequently, the data obtaining processing ends.

At this point, in a case where the processing in the step S14 has been performed, the dummy data obtained in the step S14 is recorded as a bf table, and in a case where the processing in the step S14 has not been performed, the bf table obtained in the step S12 is recorded. In addition, at the time of recording, the time information and the bf table obtained at the earliest time are replaced (overwritten) with time information and a bf table that are to be newly recorded, and consequently the bf table on the memory 43 is erased.

As described above, the terminal device 11 converts the position information into the bf table, subjects the bf table to the dummy data conversion processing as appropriate, and records the obtained bf table and the time information.

Converting the position information into the bf table enables to reduce the amount of data in comparison with original position information, and therefore the processing amount required to transmit/receive information indicating a position of the user to/from the server 12 can be reduced. In addition, combining the conversion into the bf table with the dummy data conversion processing enables to enhance the anonymity, and also eliminates the need for encryption processing of position information, and therefore the processing amount in the terminal device 11 can also be reduced correspondingly.

Explanation of Data Transmission Processing

When the data obtaining processing described above is periodically executed, pairs of the time information and the bf table are accumulated in the recording unit 45. In addition, when an opportunity to transmit infectious disease data comes, for example, when a user has received, from a doctor, a diagnosis indicating that the user has been infected with a specific infectious disease, and inputs the diagnosis by operating the input unit 41, data transmission processing is performed.

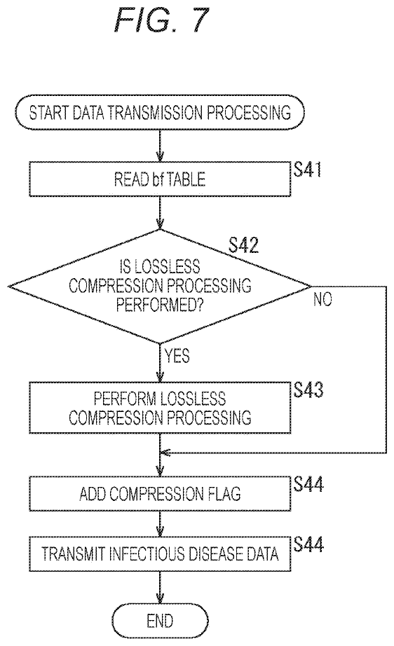

Data transmission processing by the terminal device 11 will be described below with reference to a flowchart shown in FIG. 7.

In a step S41, the control unit 44 reads, from the recording unit 45, pairs of the time information and the bf table obtained for a predetermined time period, and on the basis of a signal supplied from the input unit 41, the control unit 44 generates infectious disease name information indicating a disease name of the infectious disease with which the user has been infected.

Here, pairs of the time information and the bf table obtained for, for example, the most recent three days are read. By determining a time period, during which pairs of the time information and the bf table are read, on an infectious disease basis according to an incubation period or the like of the infectious disease, only pieces of time information and bf tables corresponding to a time period required on the server 12 side are transmitted. Consequently, useless data is not transmitted, and therefore data can be efficiently transmitted/received.

In a step S42, the control unit 44 determines whether or not to perform lossless compression processing. For example, whether or not to perform lossless compression processing is defined by settings beforehand.

In a case where it is determined in the step S42 that the lossless compression processing is performed, in a step S43, the compression processing unit 52 subjects the time information, the bf table, and the infectious disease name information obtained in the step S41 to the lossless compression processing, in other words, encoding processing. After the lossless compression processing is performed, the process proceeds to a step S44.

Meanwhile, in a case where it is determined in the step S42 that the lossless compression processing is not performed, the processing in the step S43 is not performed, and subsequently the process proceeds to the step S44.

In a case where it is determined in the step S42 that the lossless compression processing is not performed, or when the lossless compression processing is performed in the step S43, in the step S44, the control unit 44 adds a compression flag to the time information, the bf table, and the infectious disease name information.

In other words, in a case where the processing in the step S43 has been performed, the compression flag having a value of “1”, which indicates that the lossless compression processing has been performed, is added to the time information, the bf table, and the infectious disease name information that have been subjected to the lossless compression processing, and consequently infectious disease data is formed.

Meanwhile, in a case where the processing in the step S43 has not been performed, the compression flag having a value of “0”, which indicates that the lossless compression processing has not been performed, is added to the time information, the bf table, and the infectious disease name information that have not been subjected to the lossless compression processing, and consequently infectious disease data is formed.

After the infectious disease data is obtained in this manner, the control unit 44 supplies the infectious disease data to the communication unit 47.

In a step S45, the communication unit 47 transmits the infectious disease data supplied from the control unit 44 to the server 12, and the data transmission processing ends.

As described above, the terminal device 11 reads the time information and the bf table, performs the lossless compression processing as necessary to generate infectious disease data, and then transmits the infectious disease data.

In the terminal device 11, only when a user has received a diagnosis indicating that the user has been infected with an infectious disease, in other words, only when required, required infectious disease data can be transmitted to the server 12. Therefore, infectious disease data can be more efficiently transmitted/received, and consequently the communication amount and the processing amount can be reduced. In addition, subjecting the bf table and the like to the lossless compression processing as appropriate enables to reduce the amount of infectious disease data.

Explanation of Data Receiving Processing

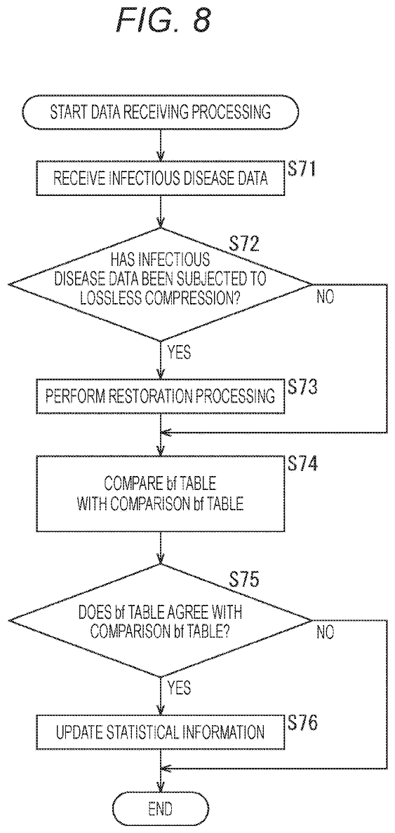

In addition, when infectious disease data is transmitted from each of the plurality of terminal devices 11, the server 12 performs data receiving processing in which the infectious disease data is received from each of the terminal devices 11 to update statistical information. Data receiving processing by the server 12 will be described below with reference to a flowchart shown in FIG. 8.

In a step S71, the communication unit 81 receives infectious disease data transmitted from the terminal device 11, and supplies the control unit 83 with the infectious disease data.

In a step S72, on the basis of a compression flag included in the infectious disease data supplied from the communication unit 81, the control unit 83 determines whether or not the infectious disease data has been subjected to lossless compression. For example, in a case where a value of the compression flag is “1”, it is determined that the infectious disease data has been subjected to lossless compression.

In a case where it is determined in the step S72 that the infectious disease data has been subjected to lossless compression, in a step S73, the restoration processing unit 91 subjects the time information, the bf table, and the infectious disease name information, which are included in the infectious disease data received in the step S71, to restoration processing, in other words, decoding processing.

After the time information, the bf table, and the infectious disease name information, which have been decoded by the restoration processing, are obtained, the process proceeds to the step S74.

Meanwhile, in a case where it is determined in the step S72 that the infectious disease data has not been subjected to lossless compression, the processing in the step S73 is not performed, and subsequently the process proceeds to the step S74. In this case, the control unit 83 extracts the time information, the bf table, and the infectious disease name information from the infectious disease data.

The infectious disease data obtained as described above is supplied to the recording unit 82, and is then recorded therein, as appropriate.

In a case where the restoration processing has been performed in the step S73, or in a case where it is determined in the step S72 that the infectious disease data has not been subjected to lossless compression, in a step S74, the comparison operation unit 92 compares a plurality of bf tables obtained from the infectious disease data with one or more comparison bf tables held beforehand. Here, for each combination of the bf table and the comparison bf table, the above-described AND operation is performed to determine whether or not the bf table agrees with the comparison bf table. In other words, a bf table that agrees with the comparison bf table is identified.

In this manner, comparing the received bf table with the predetermined comparison bf table enables to determine whether or not received infectious disease data is data related to an infectious disease in a predetermined target place.

In a step S75, as a result of the comparison in the step S74, the statistical processing unit 93 determines whether or not the bf table agrees with the comparison bf table.

In a case where it is determined in the step S75 that the bf table does not agree with the comparison bf table, the processing in a step S76 is not performed, and the data receiving processing ends.

Meanwhile, in a case where it is determined in the step S75 that the bf table agrees with the comparison bf table, the statistical processing unit 93 updates statistical information in the step S76, and the data receiving processing ends.

For example, on the basis of the bf table that agrees with the comparison bf table, time information that is associated with the bf table, and infectious disease name information, the statistical processing unit 93 updates statistical information of an infectious disease indicated by the infectious disease name information, the statistical information being recorded in the recording unit 82. As the result, for example, statistical information related to an infectious disease indicated by the infectious disease name information is updated, the infectious disease being at a position (in a place) indicated by the bf table, and in a time zone that includes the time indicated by the time information.

Updating the statistical information in this manner enables respective users of the terminal devices 11 to access the server 12, and to browse the latest statistical information, by using the terminal devices 11. For example, on receipt of a request to browse statistical information from the terminal device 11, the control unit 83 of the server 12 reads specified statistical information from the recording unit 82, and then supplies the statistical information to the communication unit 81. Subsequently, the communication unit 81 transmits the statistical information to the terminal device 11. It should be noted that the statistical information may be generated when a browsing request is received from the terminal device 11.

As described above, the server 12 receives infectious disease data from the terminal device 11, and compares the bf table included in the infectious disease data with the comparison bf table prepared beforehand, thereby determines whether or not the infectious disease data is data related to the target place and time. Consequently, the server 12 updates statistical information.

The server 12 receives infectious disease data that includes a bf table obtained by converting original position information. Therefore, the server 12 is capable of not only reducing the amount of infectious disease data that is transmitted/received to/from the terminal devices 11 while ensuring anonymity, but also reducing the processing amount at the time of receiving and at the time of statistical processing.

In the statistical information-sharing system described above, after the terminal device 11 obtains position information, the terminal device 11 immediately hashes the position information to convert the position information into a bf table, and converts a part of a bf table group into dummy data. Consequently, the terminal device 11 itself is not required to record position information that is sensitive data, either.

Data that flows through the network between the terminal device 11 and the server 12, and that is held in the server 12, is only infectious disease data that includes a concealed bf table, and that may contain dummy data, or infectious disease data that includes a bf table which has been subjected to lossless compression in such a manner that the bf table can be restored on the server 12 side. Therefore, the amount of infectious disease data can be reduced, and thus the present technology has superiority in network and storage costs as well.

In addition, when aggregation processing, that is to say, statistical processing, is performed on the basis of infectious disease data collected from each of the terminal devices 11 in the server 12, calculation is composed mainly of comparison operation of bf tables. Therefore, in particular, in a case where the amount of data per transaction between the terminal device 11 and the server 12 is large, the use amount of a Central Processing Unit (CPU) or the like that realizes the control unit 83 of the server 12 at the time of statistical processing can be reduced.

Moreover, considering the characteristic that hash values collide with each other in a bloom filter, pseudo positiveness exists in such a manner that information that does not exist is misrecognized as information that exists. However, in a system that allows pseudo positiveness, for example, a statistical processing system in which anonymity is desired to be ensured, such as a statistical information-sharing system, no particular inconvenience occurs. Therefore, from the viewpoint of reinforcement of anonymity, pseudo positiveness ensures a function equivalent to the employment of dummy data.

According to the present technology such as that described above, in particular, when an era in which a large number of Internet of Things (IoT) apparatuses transmit/receive a large amount of data comes in the future, the need for relatively high-load technologies such as Secure Sockets Layer (SSL), which are mainly required for encryption processing and anonymization when sensitive data is collected, and the need for IoT gateway servers for realizing the technologies, are eliminated. The present technology is particularly useful because of such superiority.

### Another Application Example 1 of the Present Technology

In addition, the present technology can also be applied to a system in which collection target data is, for example, closed Social Networking Service (SNS) writing information, and a function similar to, for example, Trend function of Twitter (registered trademark) is realized without obtaining real data from the closed SNS.

In such a case, for example, a service provider that manages the server 12 determines beforehand a word, the statistics of which are desired to be taken, in other words, a word that is expected to attract the interest of many users (hereinafter also referred to as “statistics target word”).

In addition, in the server 12, with respect to one or more statistics target words, comparison bf tables indicating statistics target words are generated and recorded beforehand. In other words, the statistics target words are subjected to hash function computation, and a comparison bf table is generated on the basis of hash values obtained as the result thereof. In addition, the server 12 or the like notifies the terminal device 11 of information indicating the statistics target words beforehand. It should be noted that statistics target words may be determined on a time period basis or on a time zone basis.

When a user uses a closed SNS in the terminal device 11, the terminal device 11 extracts (detects) a statistics target word from text data of the closed SNS, and in a case where the text data includes a statistics target word, the terminal device 11 subjects the included statistics target word to computation that uses hash functions, and generates a bf table. Subsequently, the terminal device 11 records the obtained bf table, and time information indicating the time at which the statistics target word has been used, with the bf table associated with the time information.

In the terminal device 11, a plurality of pairs of the bf table and the time information are recorded as a bf table log. However, as with the example of the infectious disease data described above, a part of the bf table may be subjected to dummy data conversion processing at a constant probability.

In addition, when an opportunity to transmit a bf table set by a service provider comes, the terminal device 11 subjects, as necessary, recorded data (hereinafter also referred to as “transmit data”) that includes a plurality of pairs of the bf table and the time information to lossless compression processing, and transmits the data to the server 12. It should be noted that in this case, the transmit data is adapted to include a compression flag. In addition, the transmit data may be transmitted every time a new bf table is obtained.

The server 12 receives the transmit data transmitted from the terminal device 11, restores the transmit data as necessary, and extracts the time information and the bf table from the transmit data. Subsequently, the server 12 compares the extracted bf table with the comparison bf table held beforehand, identifies a statistics target word indicated by the bf table, and generates (updates) trend information as statistical information on the basis of a result of the identification, and the time information. The trend information is, for example, information indicating a specific time zone in which users got interested in a statistics target word, the number of users who got interested in the statistics target word, and the like.

When the statistical information (trend information) is generated by the server 12, the terminal device 11 is capable of knowing a currently popular word or the like by referring to the statistical information.

It should be noted that the statistics target word may be extracted not only from the closed SNS, but also from a voice or the like emitted by a user, in the terminal device 11.

In such a case, for example, a voice generated by a user while the user appreciates a famous movie, or while the user plays a great work game, is collected by a microphone provided in the terminal device 11 or a microphone provided in a controller or the like connected to a game machine that is used as the terminal device 11. Subsequently, the terminal device 11 subjects the voice data obtained by the voice collection to voice recognition, and extracts a statistics target word. Configuring the terminal device 11 in such a manner enables to combine also the voice (word) generated by the user into the statistical information with the anonymity preserved.

According to the application example such as that described above, while a user's comment, the SNS of which is not open to the public, and information or the like, for which ordinary account creation is not performed, and which has been obtained by voice recognition by using an IoT apparatus, are collected, anonymization of those pieces of information, and a reduction in network costs of information communication, can also be realized. In particular, in comparison with the Trend function of Twitter (registered trademark), aggregation can be performed for more users with the anonymity preserved, and network costs can also be reduced.

### Another Application Example 2 of the Present Technology

Moreover, the present technology can also be applied to a system in which collection target data is some kind of information output from an IoT apparatus that exists in a town.

In this case, as with, for example, the above-described first embodiment and the another application example 1, any kind of collection target data may be used so long as the collection target data can be defined as a statistics target beforehand.

In other words, for example, results of subjecting images of items, such as clothes that are desired to be statistics targets, to image recognition can be used as collection target data. It should be noted that image information (image data) itself may be collection target data.

In this case, on the server 12 side, with respect to one or more items that are statistics targets, a comparison bf table is generated and recorded beforehand from results of subjecting images of items to image recognition.

In addition, for example, an IoT apparatus such as a camera arranged in a town is the terminal device 11, and image information or the like of an item that is a statistics target is supplied from the server 12 or the like to the terminal device 11 beforehand.

In addition, the terminal device 11 arranged in a town image-captures a street or the like in the town as an object. The terminal device 11 subjects image information obtained by image capturing (hereinafter also referred to as “captured image information”) to image recognition by using image information or the like of an item of a statistics target supplied from the server 12 beforehand, and thereby detects the item of the statistics target from the captured image information.

In a case where an item of a statistics target is detected by the captured image information, the terminal device 11 subjects an image recognition result for the item to computation that uses hash functions, and generates a bf table. Subsequently, the terminal device 11 records the obtained bf table, and time information indicating the time at which the statistics target item has been detected, with the bf table associated with the time information.

In this case, by preventing the dummy data conversion processing from being executed, in other words, setting a probability of producing dummy data is set at 0, all other pieces of information excluding false detection caused by pseudo positiveness of the bf table can be combined.

In such an example, on the assumption that, for example, predetermined brand clothes are regarded as an item of a statistics target, statistics of brand clothes worn by persons in a town can be taken.

On the terminal device 11 side, the terminal device 11 including an IoT apparatus, that is to say, a camera or the like installed in a town, a bf table of brand clothes has only to be generated, and the amount of information that flows on the network is also small, and therefore encryption processing of information that is transmitted and received is also not required.

Configuration Example of Computer

Incidentally, the series of processing described above can be executed by hardware, and can also be executed by software. In a case where the series of processing is executed by software, a program that configures the software is installed in a computer. Here, the computer includes a computer that is built into dedicated hardware, and a computer that is capable of executing various kinds of functions by installing various kinds of programs, for example, a general-purpose computer, and the like.

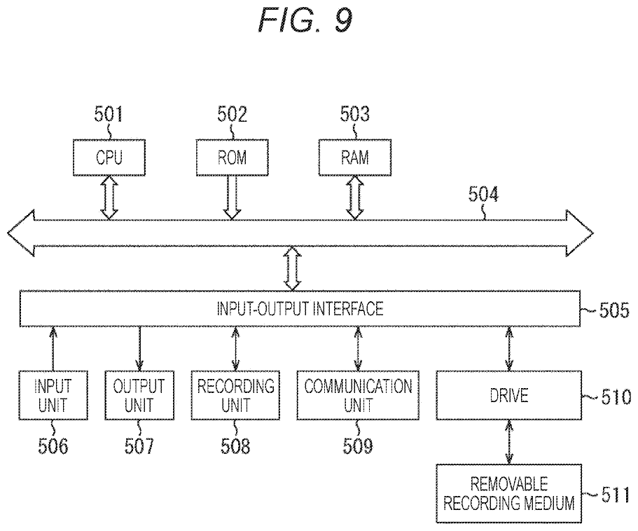

FIG. 9 is a block diagram illustrating, as an example, a hardware configuration of a computer that executes the above-described series of processing by a program.

In the computer, a CPU 501, a Read Only Memory (ROM) 502, and a Random Access Memory (RAM) 503 are mutually connected through a bus 504.

An input-output interface 505 is further connected to the bus 504. An input unit 506, an output unit 507, a recording unit 508, a communication unit 509, and a drive 510 are connected to the input-output interface 505.

The input unit 506 includes a keyboard, a mouse, a microphone, an image pickup element, and the like. The output unit 507 includes a display, a speaker array, and the like. The recording unit 508 includes a hard disk, a nonvolatile memory, and the like. The communication unit 509 includes a network interface and the like. The drive 510 drives a removable recording media 511 such as a magnetic disk, an optical disk, a magneto-optical disk, or a semiconductor memory.

In the computer that is configured as described above, the CPU 501 loads, for example, a program stored in the recording unit 508 into the RAM 503 through the input-output interface 505 and the bus 504, then executes the program, and consequently the above-described series of processing is performed.

The program executed by the computer (CPU 501) can be provided by being recorded, for example, in a removable recording media 511 such as a package media. In addition, the program can be provided through a wired or wireless transmission medium such as a local area network, the Internet, and digital satellite broadcasting.

In the computer, the program can be installed in the recording unit 508 through the input-output interface 505 by mounting the removable recording media 511 to the drive 510. In addition, the program can be received by the communication unit 509 through a wired or wireless transmission medium, and can be installed in the recording unit 508. Besides the above, the program can be installed in the ROM 502 or the recording unit 508 beforehand.

It should be noted that the program executed by the computer may be a program in which processing is time-sequentially performed along the order described in the present description, or may be a program in which processing is performed in parallel or in the required timing, for example, when a call is made.

In addition, embodiments of the present technology are not limited to the embodiments described above. Various modifications can be made within the scope that does not deviate from the gist of the present technology.

For example, the present technology can be configured as cloud computing in which one function is processed by being shared by a plurality of devices in cooperation through a network.

Further, each step explained in the above-described flowchart is executed by one device. However, the each step can be executed by being shared by a plurality of devices.

Furthermore, in a case where one step includes a plurality of processings, the plurality of processings included in the one step are executed by one device. However, the plurality of processings can be executed by being shared by a plurality of devices.

In addition, the effects described in the present description are to be construed as merely illustrative, and are not limitative, and other effects may be produced.

Moreover, the present technology may have the following configuration.

(1) An information processing device including:

a control unit that subjects information related to a collection target user to computation using one or more predetermined functions, and generates collected data on the basis of a result of the computation; and

a communication unit that transmits the collected data. (2) The information processing device set forth in the preceding (1), in which:

the control unit causes a recording unit to record a pair of the collected data and time information indicating the time at which the information related to the user has been obtained; and

the communication unit transmits a plurality of the pairs that have been obtained during a predetermined time period, the pairs being recorded in the recording unit.

(3) The information processing device set forth in the preceding (1) or (2), in which

the control unit subjects a part of a plurality of pieces of the collected data to dummy data conversion processing, and finally treats dummy data obtained by the dummy data conversion processing as the part of the collected data.

(4) The information processing device set forth in the preceding (2), in which

the communication unit transmits related information that relates to the information related to the user, and that is used for statistical processing based on the collected data, and the plurality of the pairs.

(5) The information processing device set forth in any one of the preceding (1) to (4),

further including a compression processing unit that subjects the collected data to lossless compression processing,

in which the communication unit transmits the collected data that has been subjected to the lossless compression.

(6) The information processing device set forth in any one of the preceding (1) to (5), in which

the function is a hash function.

(7) The information processing device set forth in the preceding (6), in which

the collected data is a bloom filter table.

(8) The information processing device set forth in any one of the preceding (1) to (7), in which

after the generation of the collected data, the control unit discards the information related to the user.

(9) The information processing device set forth in any one of the preceding (1) to (8), in which

the information related to the user is sensitive data.

(10) An information processing method including the steps of:

subjecting information related to a collection target user to computation using one or more predetermined functions, and generating collected data on the basis of a result of the computation; and

transmitting the collected data.

(11) A program for causing a computer to execute processing including the steps of:

subjecting information related to a collection target user to computation using one or more predetermined functions, and generating collected data on the basis of a result of the computation; and

transmitting the collected data.

(12) An information processing device including:

a communication unit that receives collected data from a plurality of terminal devices, the collected data having been obtained from information related to a collection target user; and

a control unit that compares the collected data for comparison with the collected data received from the terminal device, and that performs statistical processing according to a result of the comparison, the collected data for comparison having been generated on the basis of results of computation that uses one or more predetermined functions, and that is performed for predetermined information.

(13) The information processing device set forth in the preceding (12), in which:

the communication unit receives, from the terminal device, a plurality of pairs of the collected data and time information indicating the time at which the information related to the user has been obtained, the plurality of pairs having been obtained during a predetermined time period; and

the control unit performs the statistical processing on the basis of the comparison result and the time information.

(14) The information processing device set forth in the preceding (13), in which:

the communication unit receives related information that relates to the information related to the user, and a plurality of the pairs; and

the control unit performs the statistical processing on the basis of the comparison result, the time information, and the related information.

(15) The information processing device set forth in any one of the preceding (12) to (14), in which:

the communication unit receives the collected data that has been subjected to lossless compression processing; and

the information processing device further includes a restoration processing unit that subjects the collected data to restoration processing.

(16) The information processing device set forth in any one of the preceding (12) to (15), in which

the function is a hash function.

(17) The information processing device set forth in the preceding (16), in which

the collected data is a bloom filter table.

(18) The information processing device set forth in any one of the preceding (12) to (17), in which

the information related to the user is sensitive data.

(19) An information processing method including the steps of:

receiving collected data from a plurality of terminal devices, the collected data having been obtained from information related to a collection target user; and

comparing the collected data for comparison with the collected data received from the terminal device, and performing statistical processing according to a result of the comparison, the collected data for comparison having been generated on the basis of results of computation that uses one or more predetermined functions, and that is performed for predetermined information.

(20) A program for causing a computer to execute processing including the steps of:

receiving collected data from a plurality of terminal devices, the collected data having been obtained from information related to a collection target user; and

comparing the collected data for comparison with the collected data received from the terminal device, and performing statistical processing according to a result of the comparison, the collected data for comparison having been generated on the basis of results of computation that uses one or more predetermined functions, and that is performed for predetermined information.

### REFERENCE SIGNS LIST

11 Terminal device
12 Server
42 Position information obtaining unit
43 Memory
44 Control unit
45 Recording unit
47 Communication unit
51 Table generation unit
52 Compression processing unit
81 Communication unit
82 Recording unit
83 Control unit
91 Restoration processing unit
92 Comparison operation unit
93 Statistical processing unit

1. An information processing device comprising:
a control unit that subjects information related to a collection target user to computation using one or more predetermined functions, and generates collected data on a basis of a result of the computation; and
a communication unit that transmits the collected data.

2. The information processing device according to claim 1, wherein:
the control unit causes a recording unit to record a pair of the collected data and time information indicating the time at which the information related to the user has been obtained; and
the communication unit transmits a plurality of the pairs that have been obtained during a predetermined time period, the pairs being recorded in the recording unit.

3. The information processing device according to claim 1, wherein
the control unit subjects a part of a plurality of pieces of the collected data to dummy data conversion processing, and finally treats dummy data obtained by the dummy data conversion processing as the part of the collected data.

4. The information processing device according to claim 2, wherein
the communication unit transmits related information that relates to the information related to the user, and that is used for statistical processing based on the collected data, and the plurality of the pairs.

5. The information processing device according to claim 1, further comprising
a compression processing unit that subjects the collected data to lossless compression processing,
wherein the communication unit transmits the collected data that has been subjected to the lossless compression.

6. The information processing device according to claim 1, wherein
the function is a hash function.

7. The information processing device according to claim 6, wherein
the collected data is a bloom filter table.

8. The information processing device according to claim 1, wherein
after the generation of the collected data, the control unit discards the information related to the user.

9. The information processing device according to claim 1, wherein
the information related to the user is sensitive data.

10. An information processing method comprising the steps of:
subjecting information related to a collection target user to computation using one or more predetermined functions, and generating collected data on a basis of a result of the computation; and
transmitting the collected data.

11. A program for causing a computer to execute processing comprising the steps of:
subjecting information related to a collection target user to computation using one or more predetermined functions, and generating collected data on a basis of a result of the computation; and
transmitting the collected data.

12. An information processing device comprising:
a communication unit that receives collected data from a plurality of terminal devices, the collected data having been obtained from information related to a collection target user; and
a control unit that compares the collected data for comparison with the collected data received from the terminal device, and that performs statistical processing according to a result of the comparison, the collected data for comparison having been generated on a basis of results of computation that uses one or more predetermined functions, and that is performed for predetermined information.

13. The information processing device according to claim 12, wherein:
the communication unit receives, from the terminal device, a plurality of pairs of the collected data and time information indicating the time at which the information related to the user has been obtained, the plurality of pairs having been obtained during a predetermined time period; and
the control unit performs the statistical processing on a basis of the comparison result and the time information.

14. The information processing device according to claim 13, wherein:
the communication unit receives related information that relates to the information related to the user, and a plurality of the pairs; and
the control unit performs the statistical processing on a basis of the comparison result, the time information, and the related information.

15. The information processing device according to claim 12, wherein:
the communication unit receives the collected data that has been subjected to lossless compression processing; and
the information processing device further comprises a restoration processing unit that subjects the collected data to restoration processing.

16. The information processing device according to claim 12, wherein
the function is a hash function.

17. The information processing device according to claim 16, wherein
the collected data is a bloom filter table.

18. The information processing device according to claim 12, wherein
the information related to the user is sensitive data.

19. An information processing method comprising the steps of:
receiving collected data from a plurality of terminal devices, the collected data having been obtained from information related to a collection target user; and
comparing the collected data for comparison with the collected data received from the terminal device, and performing statistical processing according to a result of the comparison, the collected data for comparison having been generated on a basis of results of computation that uses one or more predetermined functions, and that is performed for predetermined information.

20. A program for causing a computer to execute processing comprising the steps of:
receiving collected data from a plurality of terminal devices, the collected data having been obtained from information related to a collection target user; and
comparing the collected data for comparison with the collected data received from the terminal device, and performing statistical processing according to a result of the comparison, the collected data for comparison having been generated on a basis of results of computation that uses one or more predetermined functions, and that is performed for predetermined information.
